(19) United States
(12) Patent Application Publication
(10) Pub. No.: US 2013/0336710 A1
(43) Pub. Date: Dec. 19, 2013

(54) Plastic Unit

(71) Applicant: Tien-Ming CHOU, Taichung City (TW)

(72) Inventor: Tien-Ming CHOU, Taichung City (TW)

(21) Appl. No.: 13/517,752

(22) Filed: Jun. 14, 2012

(51) Int. Cl. F16B 11/00

(52) U.S. Cl. 403/270

(57) ABSTRACT

A plastic unit to be assembled by welding includes first and second members, and an interconnecting member for interconnecting the first and second members. The first member extends in an axial direction. The second member caps the first member, and is in contact with the first member at a first junction extending in the axial direction and terminating at opposite first and second ends, a second junction adjacent to the first end and extending in an inward direction, and a third junction adjacent to the first end and extending in an inward direction. The interconnecting member includes first, second and third interconnecting portions disposed at the first, second and third junctions, respectively.

### BACKGROUND OF THE INVENTION

1. Field of the Invention

The invention relates to a plastic unit, more particularly to a plastic unit to be assembled by welding.

2. Description of the Related Art

Referring to FIG. 1, a conventional plastic unit 1 disclosed in Taiwanese Patent Publication No. 201127611 includes first and second components 11, 12 to be interconnected by ultrasonic welding. The first component 11 is hollow and has an end portion 111 formed with a space 112 surrounding an axis (a) and extending in an axial direction along the axis (a). The second member 12 is disposed at the end portion 111 of the first member 11 to cap thereon and is formed with a protrusion 121 confronting and disposed in the space 112.

Further referring to FIG. 2, after an ultrasonic welding process is applied to the plastic unit 1, the first and second components 11, 12 are interconnected since a portion of the protrusion 121 of the second member 12 is melted and received in the space 112 of the first member 11.

However, when a size of the plastic unit 1 is reduced as needed, a size of the protrusion 121 of the second component 12 is also reduced so as to prevent overflow of the melted protrusion 121, thereby resulting in a relatively weak connecting strength between the first and second members 3, 4.

### SUMMARY OF THE INVENTION

Therefore, the object of the present invention is to provide a plastic unit having a relatively strong connecting strength after welding.

According to the present invention, a plastic unit to be assembled by welding comprises a first member, a second member, and an interconnecting member. The first member surrounds an axis and extends in an axial direction along the axis. The second member is disposed at one end of the first member in the axial direction, caps the first member, and is in contact with the first member at a first junction, a second junction and a third junction. The first junction surrounds the axis, extends in the axial direction, and terminates at opposite first and second ends. The second junction is adjacent to the first end of the first junction and extends in an inward direction perpendicular to the axial direction. The third junction is adjacent to the second end of the first junction and extends in an outward direction perpendicular to the axial direction and opposite to the inward direction. The interconnecting member is for interconnecting the first member and the second member and includes a first interconnecting portion, at least one second interconnecting portion and a third interconnecting portion disposed at the first, second and third junctions, respectively.

### BRIEF DESCRIPTION OF THE DRAWINGS

Other features and advantages of the present invention will become apparent in the following detailed description of the preferred embodiment with reference to the accompanying drawings, of which:

FIG. 1 is a sectional view of a conventional plastic unit including first and second components disclosed in Taiwanese Patent Publication No. 201127611;

FIG. 2 is a sectional view of the first and second components after being interconnected by ultrasonic welding;

FIG. 3 is a sectional view of a preferred embodiment of a plastic unit including first and second members to be interconnected by welding according to the present invention;

FIG. 4 is an enlarged fragmentary sectional view of the first and second members of the plastic unit of the preferred embodiment;

FIG. 5 is a sectional view of the plastic unit of the preferred embodiment, where the first and second members are interconnected by welding; and

FIG. 6 is an enlarged fragmentary sectional view of the plastic unit of the preferred embodiment, where the first and second members are interconnected by welding.

### DETAILED DESCRIPTION OF THE PREFERRED EMBODIMENT

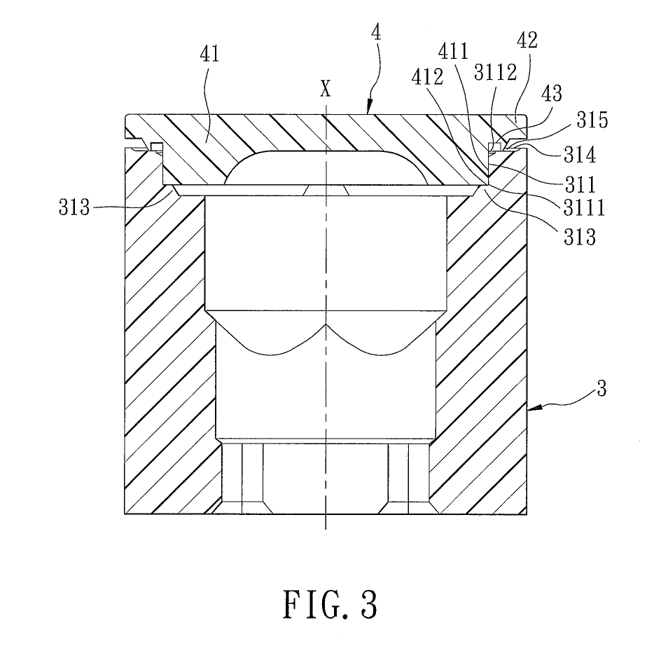

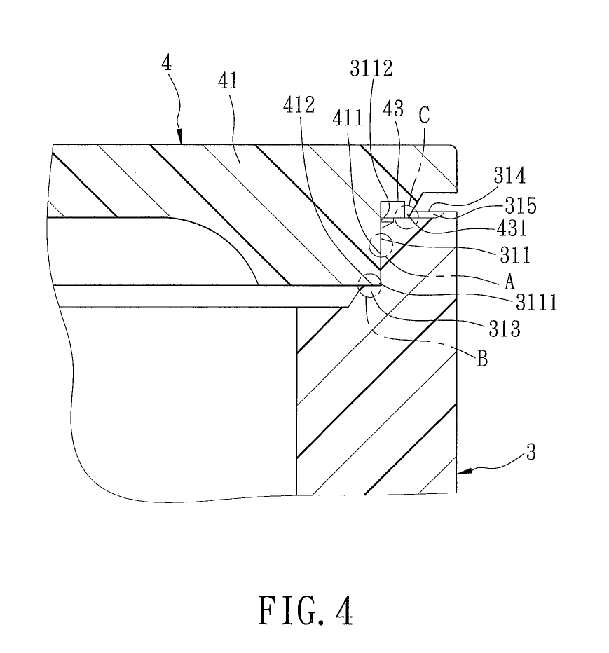

Referring to FIGS. 3 and 4, a preferred embodiment of a plastic unit to be assembled by welding according to the present invention is shown. The plastic unit is for application to a switch and comprises a hollow first member 3, a second member 4 capping the first member 3, and an interconnecting member for interconnecting the first and second members 3, 4. The first member 3 and the second member 4 are in contact with each other at a first junction, a second junction and a third junction. The first junction surrounds an axis (X), extends in an axial direction along the axis (X), and terminates at opposite first and second ends 3111 and 3112. The second junction is adjacent to the first end 3111 of the first junction and extends in an inward direction perpendicular to the axial direction. The third junction is adjacent to the second end 3112 of the first junction and extends in an outward direction perpendicular to the axial direction and opposite to the inward direction. The interconnecting member includes a first interconnecting portion (A), a plurality of second interconnecting portions (B), and a third interconnecting portion (C) that are disposed at the first, second and third junctions, respectively.

The first member 3 surrounds the axis (X), extends in the axial direction along the axis (X), and has an inner surface 311 and a distal surface 314. The inner surface 311 surrounds the axis (X), and is formed with a part of the first interconnecting portion (A) at the first junction of the first and second members 3, 4, and a plurality of stepped portions 313 each extending from the first end 3111 of the first junction in the inward direction to form a part of a respective one of the second interconnecting portions (B).

Each of the stepped portions 313 protrudes from the first member 3 toward the second member 4 in the axial direction and is disposed adjacent to the first end 3111 of the first junction in the inward direction. In this embodiment, there are two pairs of the stepped portions 313 (i.e., two pairs of the second interconnecting portions (B)), each pair of which are arranged opposite to each other diagonally.

The distal surface 314 of the first member 3 is spaced apart from the stepped portions 313 in the axial direction and extends from the second end 3112 of the first junction in the outward direction. In this embodiment, the distal surface 314 of the first member 3 is formed with a groove 315.

The second member 4 is disposed at the distal surface 314 of the first member 3 in the axial direction and complements the first member 3 at the first, second and third junctions. The second member 4 includes a main portion 41, a flange 42, and a shoulder portion 43. The main portion 41 extends into the first member 3 in the axial direction and has an outer surrounding surface 411 in contact with the inner surface 311 of the first member 3 at the first junction and an end surface 412 in contact with the stepped portions 313 of the first member 3 at the second junction. In particular, the inner surface 311 of the first member 3 and the outer surrounding surface 411 of the main portion 41 cooperatively form the first interconnecting portion (A), and each of the stepped portions 313 of the first member 3 and the end surface 412 cooperatively form a respective one of the second interconnecting portions (B).

The flange 42 of the second member 4 extends from the main portion 41 in the outward direction. The shoulder portion 43 is disposed between the main portion 41 and the flange 42, protrudes from the flange 42 toward the distal surface 314 of the first member 3 to form a downward converging protrusion 431 that abuts against and is tapered toward the distal surface 314 at the third junction, that serves as a part of the third interconnecting portion (C), and that is spaced apart from the outer surrounding surface 411 of the main portion 42 in the outward direction. In this embodiment, the downward converging protrusion 431 corresponds to and is disposed in the groove 315 formed in the distal surface 314 in position. In particular, the downward converging protrusion 431 and the distal surface 314 cooperatively form the third interconnecting portion (C).

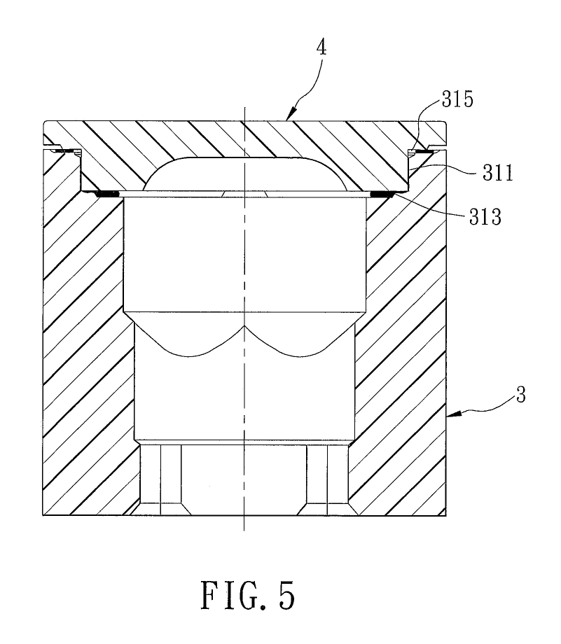

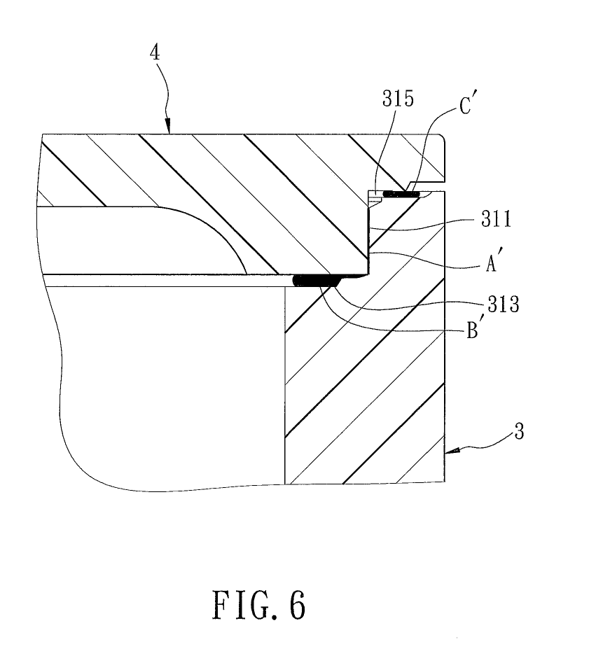

Referring to FIGS. 5 and 6, when an ultrasonic welding process is applied to the first and second members 3, 4, the first, second and third interconnecting portions (A), (B) and (C) of the interconnecting member are melted into first, second and third interconnecting portions A′, B′ and C′, such that the first and second members 3, 4 are interconnected. In particular, an axially extending part of the inner surface 311 and the outer surrounding surface 411, the stepped portions 313 and the end surface 412, and the downward converging protrusion 431 and the distal surface 314 are melted and interconnected, respectively.

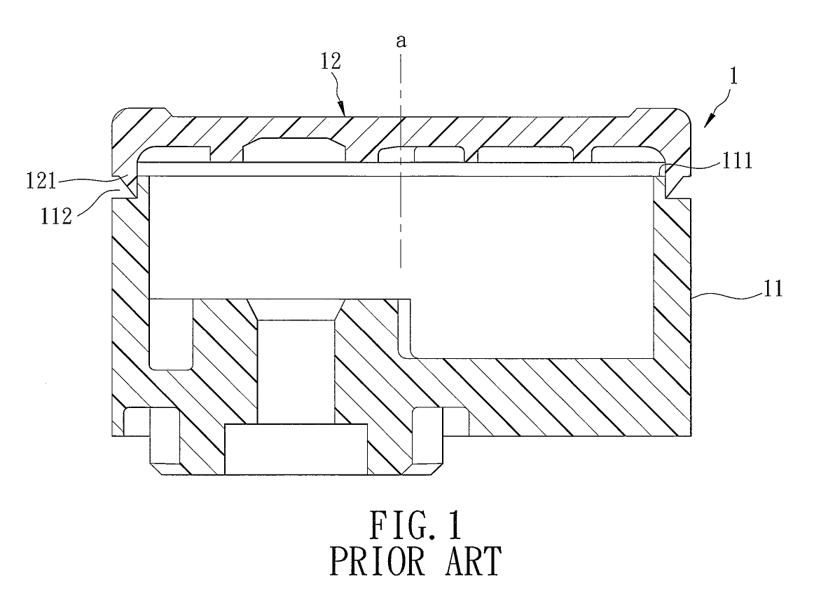

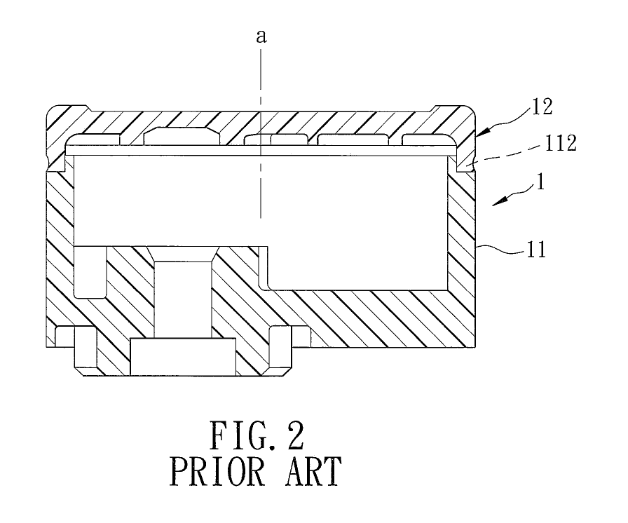

To sum up, the connecting strength between the first and second members 3, 4 after ultrasonic welding can be enhanced since the first, second and third interconnecting portions (A), (B) and (C) extend in different directions. Additionally, the configuration of the groove 315 and a space formed between the end surface 412 of the main portion 41 of the second member 4 and the inner surface 311 of the first member 3 provide sufficient space for accommodating the melted downward converging protrusion 431 and the stepped portions 313 so as to prevent overflow of the melted downward converging protrusion 431 and the stepped portions 313. By this way, as compared to the conventional plastic unit 1 as illustrated in FIGS. 1 and 2, the visual aesthetic quality of the plastic unit of the present invention can be ensured when a size of the plastic unit is reduced as needed.

While the invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A plastic unit to be assembled by welding, comprising:
a first member surrounding an axis and extending in an axial direction along the axis;
a second member disposed at one end of said first member in the axial direction, capping said first member, and in contact with said first member at
a first junction surrounding the axis, extending in the axial direction, and terminating at opposite first and second ends,
a second junction adjacent to said first end of said first junction and extending in an inward direction perpendicular to the axial direction, and
a third junction adjacent to said second end of said first junction and extending in an outward direction perpendicular to the axial direction and opposite to the inward direction; and
an interconnecting member for interconnecting said first member and said second member, said interconnecting member including a first interconnecting portion, at least one second interconnecting portion and a third interconnecting portion disposed at said first, second and third junctions, respectively.

2. The plastic unit as claimed in claim 1, wherein said first member is hollow and has
an inner surface formed with a part of said first interconnecting portion and a part of said second interconnecting portion, and having at least one stepped portion that extends from said first end of said first interconnecting portion in the inward direction to form said part of said second interconnecting portion, and
a distal surface spaced apart from said stepped portion in the axial direction and extending from said second end of said first junction in the outward direction.

3. The plastic unit as claimed in claim 2, wherein said second member includes:
a main portion extending into said first member in the axial direction, and having
an end surface in contact with said stepped portion so as to cooperatively form said second interconnecting portion therebetween, and
an outer surrounding surface surrounding the axis and in contact with said inner surface of said first member so as to cooperatively form said first interconnecting portion therebetween;
a flange extending from said main portion in the outward direction; and
a shoulder portion disposed between said main portion and said flange, and abutting against said distal surface of said first member so as to cooperatively form said third interconnecting portion therebetween.

4. The plastic unit as claimed in claim 3, wherein said inner surface of said first member is formed with a plurality of said stepped portions in contact with said end surface of said main portion of said second member.

5. The plastic unit as claimed in claim 3, wherein said distal surface of said first member is formed with a groove at said third junction and corresponding to and confronting said shoulder portion of said second member in position.

6. The plastic unit as claimed in claim 5, wherein said shoulder portion of said second member protrudes from said flange toward said distal surface of said first member, and is spaced apart from said outer surrounding surface of said main portion in the outward direction.

7. The plastic unit as claimed in claim 1, wherein said first, second and third interconnecting portions of said interconnecting member are to be melted by ultrasonic welding for interconnecting said first and second members.
